(19) United States
(12) Patent Application Publication
(10) Pub. No.: US 2013/0026903 A1
(43) Pub. Date: Jan. 31, 2013

(54) SPARK PLUG

(71) Applicants: Tsutomu Shibata, Owariasahi (JP); Tomo-o Tanaka, Kitanagoya (JP); Daisuke Sumoyama, Nagoya (JP); Takaaki Kikai, Ama (JP)

(72) Inventors: Tsutomu Shibata, Owariasahi (JP); Tomo-o Tanaka, Kitanagoya (JP); Daisuke Sumoyama, Nagoya (JP); Takaaki Kikai, Ama (JP)

(73) Assignee: NGK Spark Plug Co., LTD., Nagoya (JP)

(21) Appl. No.: 13/638,641

(22) PCT Filed: Jan. 18, 2011
(86) PCT No.: PCT/JP2011/000213

§ 371 Date: Oct. 1, 2012

(30) Foreign Application Priority Data
Apr. 2, 2010 (JP) 2010-085887

(51) Int. Cl. H01T 13/39

(52) U.S. Cl. 313/141

(57) ABSTRACT

An electrode tip located at an distal end of an electrode of a spark plug comprises Pd as a predominant component in an amount of 40 wt. % or more; at least one element of Ir, Ni, Co, and Fe, wherein, when the tip contains Ir, the amount of Ir is 0.5 wt. % to 20 wt. %, and when the tip contains at least one element of Ni, Co, and Fe, the amount of the at least one element is 0.5 wt. % to 40 wt. %; and at least one element of Pt, Re, Rh, and Ru in a total amount of 5 wt. % to 40 wt. %, wherein when the tip contains at least one element of Re, Rh, and Ru, the amount of the at least one element is 10 wt. % or less, and when the tip contains Pt, the amount of Pt is 16 wt. % to 40 wt. %. The electrode tip, which comprises Pd as the main component, has improved resistance to spark-caused wear and reduced occurrence of separation and cracking of the tip.

### CROSS-REFERENCE TO RELATED PATENT APPLICATIONS

This application is a U.S. National Phase Application under 35 U.S.C. §371 of International Patent Application No. PCT/JP2011/000213, filed Jan. 18, 2011, and claims the benefit of Japanese Patent Application No. 2010-085887, filed Apr. 2, 2010, all of which are incorporated by reference herein. The International Application was published in Japanese on Oct. 13, 2011 as International Publication No. WO/2011/125267 under PCT Article 21(2).

### FIELD OF THE INVENTION

The present invention relates to the composition of an electrode tip provided at a distal end of an electrode of a spark plug.

### BACKGROUND OF THE INVENTION

Conventionally, platinum (Pt) has been practically used as a material of an electrode tip provided at a distal end of an electrode of a spark plug. In addition, there has been proposed an electrode tip which uses palladium (Pd) as an alternative to Pt, which is a rare metal (see, for example, Patent Document 1).

However, an electrode tip formed of Pd has a problem in that its resistance to wear caused by spark (i.e., spark wear resistance) is lower than that of an electrode tip formed of Pt because Pd is lower in meting point than Pt, and that the electrode tip formed of Pd suffers separation or cracking due to grain growth when the temperature of a combustion chamber in which the electrode tip is disposed is high.

### PRIOR ART DOCUMENT

### Patent Document

Patent Document 1: Japanese Patent Publication (kokoku) No. 5-47954
Patent Document 2: Japanese Patent Application Laid-Open (kokai) No. 10-22053
Patent Document 3: Japanese Patent Application Laid-Open (kokai) No. 2002-83663
Patent Document 4: WO 2008/014192

### PROBLEMS TO BE SOLVED BY THE INVENTION

The present invention has been conceived to solve the above-described problem, and an object of the present invention is to provide a technique which enhances the spark wear resistance of an electrode tip whose predominant component is Pd and restrains occurrence of separation and cracking of the electrode tip.

### SUMMARY OF THE INVENTION

### Means for Solving the Problem

To solve, at least partially, the above problem, the present invention can be embodied in the following modes or application examples.

Application example 1: A spark plug comprising an electrode tip at a distal end of an electrode, characterized in that the electrode tip contains:

Pd as a predominant component in an amount of 40 wt. % or more;

at least one element of Ir, Ni, Co, and Fe, wherein, when the tip contains Ir, the amount of Ir is 0.5 wt. % to 20 wt. %, and when the tip contains at least one element of Ni, Co, and Fe, the amount of the at least one element is 0.5 wt. % to 40 wt. %; and

at least one element of Pt, Re, Rh, and Ru in a total amount of 5 wt. % to 40 wt. %, wherein when the tip contains at least one element of Re, Rh, and Ru, the amount of the at least one element is 10 wt. % or less, and when the tip contains Pt, the amount of Pt is 16 wt. % to 40 wt. %.

A spark plug according to application example 1 enables the melting point of the electrode tip to rise and restrain embrittlement of the electrode tip. Therefore, it is possible to enhance the spark wear resistance of the electrode tip whose predominant component is Pd and to restrain occurrence of separation and cracking of the electrode tip.

Application example 2: The spark plug described in the application example 1, wherein the electrode tip further contains any of Ti, Zr, Hf, and rare earth elements in an amount of 0.05 wt. %, to 0.5 wt. %.

According to the spark plug of application example 2, since grain growth of the electrode tip can be restrained, the spark wear resistance of the electrode tip whose predominant component is Pd can be enhanced further, and occurrence of separation and cracking of the electrode tip can also be restrained further.

Notably, the present invention can be implemented in various modes. For example, the present invention can be implemented in the form of a method of manufacturing a spark plug, an apparatus for manufacturing a spark plug, or the like.

### BRIEF DESCRIPTION OF THE DRAWINGS

These and other features and advantages of the present invention will become more readily appreciated when considered in connection with the following detailed description and appended drawings, wherein like designations denote like elements in the various views, and wherein:

FIG. 1 is a partially sectional view of a spark plug 100 according to an embodiment of the present invention.

FIG. 2 is an enlarged view of a front end portion 22 of a center electrode 20 of the spark plug 100 and its surrounding.

FIG. 3 is a cross-sectional view showing, on an enlarged scale, a joint portion between an electrode tip 90, 95 and an electrode 20, 30.

FIG. 4 is an explanatory view showing, in a table form, compositions of electrode tip materials used for Samples 1 to 32 and the results of an evaluation test performed for these samples.

FIG. 5 is an explanatory view showing, in a table form, compositions of electrode tip materials used for Samples 33 to 43 and the results of an evaluation test performed for these samples.

### DETAILED DESCRIPTION OF THE INVENTION

### Mode for Carrying Out the Invention

An embodiment of the present invention will now be described in the following order.

### A. Embodiment:

A1. Structure of spark plug:

A2. Composition of electrode tip:

A3. Composition of electrode:

B. Experimental example:
C. Modifications of embodiment:

### A. Embodiment

### A1. Structure of Spark Plug:

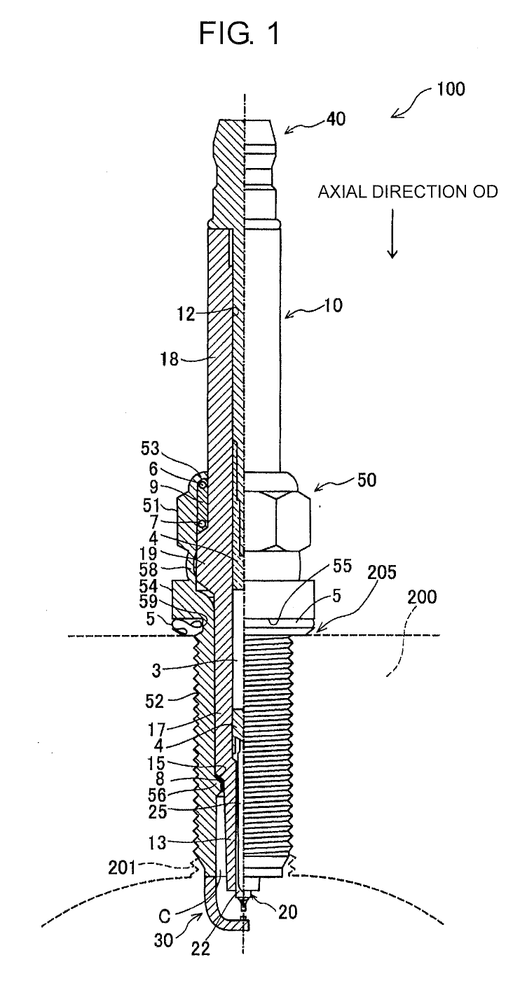

FIG. 1 is a partially sectional view showing a spark plug 100 according to an embodiment of the present invention. In the following description, an axial direction OD of the spark plug 100 in FIG. 1 is referred to as the vertical direction, the lower side of the spark plug 100 in FIG. 1 is referred to as the front end side of the spark plug 100, and the upper side as the rear end side.

The spark plug 100 includes a ceramic insulator 10, a metallic shell 50, a center electrode 20, a ground electrode 30, and a metal terminal 40. The center electrode 20 extending in the axial direction OD is held in the insulator 10. The insulator 10 provides electrical insulation, and the metallic shell 50 holds the insulator 10. The metal terminal 40 is mounted to the rear end portion of the insulator 10.

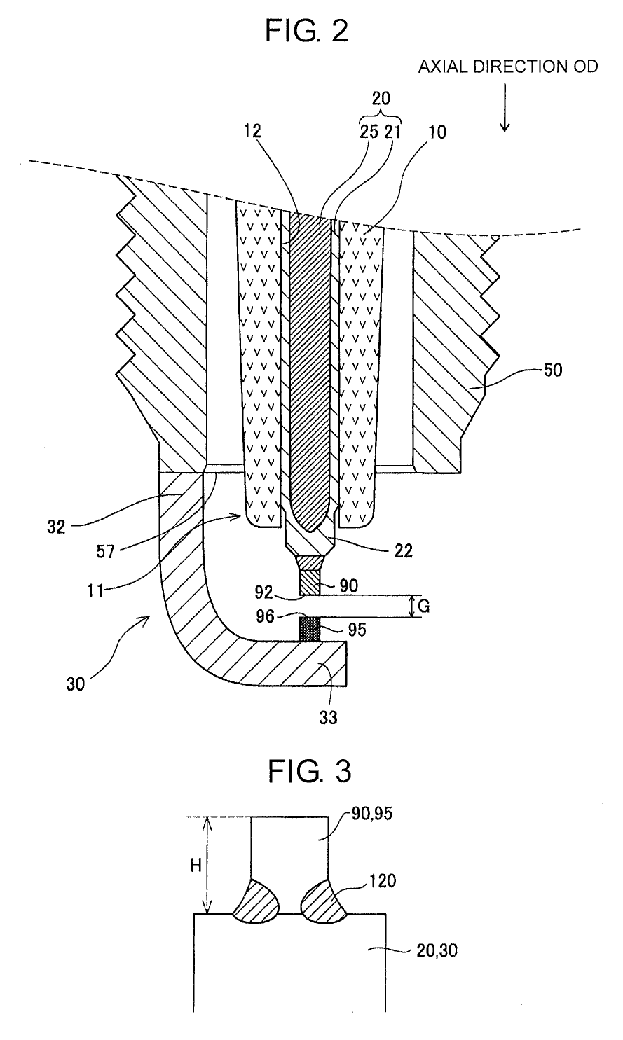

The center electrode 20 disposed in an axial hole 12 of the insulator 10 extends toward the rear end side, and is electrically connected to the metal terminal 40 via a seal members 4 and a ceramic resistor 3. A high-voltage cable (not shown) is connected to the metal terminal 40 via a plug cap (not shown) so as to apply high voltage to the metal terminal 40. The structures of the center electrode 20 and the ground electrode 30 will be described later using FIG. 2.

The insulator 10 is formed from alumina, etc. through firing and has a cylindrical tubular shape, and its axial hole 12 extends coaxially along the axial direction OD. The insulator 10 has a flange portion 19 having the largest outside diameter and located approximately at the center with respect to the axial direction OD and a rear trunk portion 18 located rearward (upward in FIG. 1) of the flange portion 19. The insulator 10 also has a front trunk portion 17 smaller in outside diameter than the rear trunk portion 18 and located frontward (downward in FIG. 1) of the flange portion 19, and a leg portion 13 smaller in outside diameter than the front trunk portion 17 and located frontward of the front trunk portion 17. The leg portion 13 is reduced in diameter in the frontward direction and is exposed to a combustion chamber of an internal combustion engine when the spark plug 100 is mounted to an engine head 200 of the engine. A stepped portion 15 is formed between the leg portion 13 and the front trunk portion 17.

The metallic shell 50 is a cylindrical tubular metallic member formed from low-carbon steel, and is adapted to fix the spark plug 100 to the engine head 200 of the internal combustion engine. The metallic shell 50 holds the insulator 10 therein while surrounding the insulator 10 in a region extending from a portion of the rear trunk portion 18 to the leg portion 13.

The metallic shell 50 has a tool engagement portion 51 and a mounting threaded portion 52. The tool engagement portion 51 allows a spark wrench (not shown) to be fitted thereto. The mounting threaded portion 52 of the metallic shell 50 has a thread formed thereon, and is screwed into a mounting threaded hole 201 of the engine head 200 provided at an upper portion of the internal combustion engine.

The metallic shell 50 has a flange-like seal portion 54 formed between the tool engagement portion 51 and the mounting threaded portion 52. An annular gasket 5 formed by folding a sheet is fitted to a screw neck 59 between the mounting threaded portion 52 and the seal portion 54. When the spark plug 100 is mounted to the engine head 200, the gasket 5 is crushed and deformed between a seat surface 55 of the seal portion 54 and a peripheral surface 205 around the opening of the mounting threaded hole 201. The deformation of the gasket 5 provides a seal between the spark plug 100 and the engine head 200, thereby preventing leakage of gas from the interior of the engine via the mounting threaded hole 201.

The metallic shell 50 has a thin-walled crimp portion 53 located rearward of the tool engagement portion 51. The metallic shell 50 also has a contractive deformation portion 58, which is thin-walled similar to the crimp portion 53, between the seal portion 54 and the tool engagement portion 51. Annular ring members 6, 7 intervene between an outer circumferential surface of the rear trunk portion 18 of the insulator 10 and an inner circumferential surface of the metallic shell 50 extending from the tool engagement portion 51 to the crimp portion 53. Further, a space between the two ring members 6, 7 is filled with powder of talc 9. When the crimp portion 53 is crimped such that the crimp portion 53 is bent inward, the insulator 10 is pressed forward within the metallic shell 50 via the ring members 6, 7 and the talc 9. As a result of the pressing, the stepped portion 15 of the insulator 10 is held by a stepped portion 56 formed on the inner circumference of the metallic shell 50, whereby the metallic shell 50 and the insulator 10 are united together. At this time, gas tightness between the metallic shell 50 and the insulator 10 is maintained by an annular sheet packing 8 provided between the stepped portion 15 of the insulator 10 and the stepped portion 56 of the metallic shell 50, whereby outflow of combustion gas is prevented. The contractive deformation portion 58 is configured such that it deforms outward due to a compression force applied thereto during the crimping operation, thereby increasing the compression amount of the talc 9, whereby the gas tightness within the metallic shell 50 is enhanced. Notably, a clearance C of a predetermined dimension is provided between the insulator 10 and a portion of the metallic shell 50 which extends frontward from the stepped portion 56 thereof.

FIG. 2 is an enlarged view of a front end portion 22 of the center electrode 20 of the spark plug 100 and its surrounding. The center electrode 20 is a rod-like electrode having a structure in which a core 25 is embedded within an electrode base member 21. The electrode base member 21 is formed of nickel (Ni) or an alloy, such as INCONEL (trademark) 600 or 601, which contains Ni as a predominant component. The core 25 is formed of copper (Cu) or an alloy which contains Cu as a predominant component, copper and the alloy being superior in thermal conductivity to the electrode base member 21. Usually, the center electrode 20 is fabricated as follows: the core 25 is displaced within the electrode base member 21 which is formed into a closed-bottomed tubular shape, and the resultant assembly is drawn by extrusion from the bottom side. The core 25 is formed such that, while its trunk portion has a substantially constant outside diameter, its front end portion is tapered.

The front end portion 22 of the center electrode 20 projects from the front end portion 11 of the insulator 10. A center electrode tip 90 is joined to the front end surface of the front end portion 22 of the center electrode 20. The center electrode tip 90 assumes the form of an approximate cylindrical column which extends in the axial direction OD. Notably, the specific composition of the center electrode tip 90 will be described later.

The ground electrode 30 is formed of a metal having high corrosion resistance; for example, a Ni alloy such as INCONEL (trademark) 600 or 601. A proximal end portion 32 of the ground electrode 30 is joined to a front end surface 57 of the metallic shell 50 through welding. The ground electrode 30 is bent such that a distal end portion 33 of the ground electrode 30 faces an end surface 92 of the center electrode tip 90.

In addition, a ground electrode tip 95 is joined to the distal end portion 33 of the ground electrode 30. An end surface 96 of the ground electrode tip 95 faces the end surface 92 of the center electrode tip 90. Notably, the ground electrode tip 95 may be formed of the same material as that of the center electrode tip 90. Hereinafter, the center electrode 20 and the ground electrode 30 will collectively be referred to as the “electrode 20, 30,” and the ground electrode tip 95 and the center electrode tip 90 as the “electrode tip 90, 95.” Meanwhile, a spark discharge gap G (mm), which is a gap for spark generation, is formed between the center electrode tip 90 and the ground electrode tip 95. The structure of the spark plug 100 is not limited to the above-described structure, but may be less complex or more complex.

### A2. Composition of Electrode Tip:

FIG. 3 is a cross-sectional view showing, on an enlarged scale, a joint portion between the electrode tip 90, 95 and the electrode 20, 30. FIG. 3 shows an example in which the electrode tip 90,95 is welded directly to the electrode 20, 30. The electrode tip 90, 95 is formed of an alloy whose predominant component is Pd; i.e., an alloy which contains Pd in the largest amount (wt. %).

The electrode tip 90, 95 is joined to the electrode 20, 30 through laser welding, and a laser weld 120 is formed at the joint portion thereof. Since the laser weld 120 is formed when the electrode tip 90, 95 is welded to the electrode 20, 30, the laser weld 120 contains metallic components of both the electrode tip 90, 95 and the electrode 20, 30. Notably, the electrode tip 90, 95 may be joined to the electrode 20, 30 by means of other techniques such as resistance welding.

Preferably, the material (electrode tip material) of the electrode tip 90, 95 contains Pd in an amount of 40 wt. % or more. The reason is that there is a demand for an electrode which contains a large amount of Pd because Pd is less scarce, easier to utilize, and inexpensive, compared with Pt.

Moreover, preferably, the electrode tip material contains iridium (Ir) in an amount of 0.5 wt. % to 20 wt. %. Addition of Ir to the electrode tip material increases the melting temperature and enhances the spark wear resistance. This is because the increased melting point decreases the sputtering rate of the electrode tip material and suppresses grain growth which occurs due to temperature increase when the spark plug is operated in the internal combustion engine. Notably, the sputtering rate refers to the ratio of the number of sputtered atoms of a sample solid to the number of ions incident on the surface of the sample solid. Meanwhile, grain growth causes cracking at the grain boundary, and it is known that, if the degree of grain growth of the electrode material during the operation in the internal combustion engine is high, separation or cracking occurs. Since Ir and Pd form a complete solid solution, the greater the amount of Ir, the higher the melting point and the greater the effect of decreasing the spluttering rate. In order to effectively raise the melting point of the electrode tip material and restrain grain growth, preferably, Ir is added in an amount of 0.5 wt. % or more, and more preferably, 12 wt. % or more.

Meanwhile, although Ir and Pd form a complete solid solution, addition of a large amount of Ir results in spinodal decomposition. For example, in the case where the Pd content is 37 wt. %, a two-phase region (Ir solid solution+Pd solid solution) appears at 1482° C. or lower. As a result, at the microscopic level, the electrode tip has a portion whose composition differs from a desired composition, and it becomes difficult to achieve the above-described effect. In addition, due to the above-described two-phase separation, the electrode tip material embrittles and is likely to crack or separate in the cooling cycle when the spark plug is operated in the internal combustion engine. In addition, the electrode tip material in which two-phase separation has occurred may decrease in workability, which lowers productivity. In view of the above-mentioned points, preferably, the amount of Ir is 20 wt. % or less, more preferably, 16 wt. % or less.

Meanwhile, preferably, the electrode tip material contains at least one of nickel (Ni), cobalt (Co), and iron (Fe) in addition to or in place of Ir. In the case where the electrode tip material contains at least one of Ni, Co, and Fe, preferably, the amount of each element is 0.5 wt. % to 40 wt. %. Since Ni, Co and Fe are elements whose sputtering rate is low, the spark wear resistance of the electrode tip material can be enhanced. Meanwhile, the electrode tip 90, 95 of the present embodiment is joined to the electrode 20, 30 formed of Ni or an alloy whose predominant component is Ni. The difference in coefficient of thermal expansion between Pd and Ni at room temperature is approximately 3 ppm (parts per million)/° C. Similarly, the difference in coefficient of thermal expansion between Pd and Co (or Fe) is small. Accordingly, addition of Ni, Co, or Fe to the electrode tip material diminishes the difference in coefficient of thermal expansion between the electrode tip 90, 95 and the electrode 20, 30, thereby enhancing bondability between the electrode tip 90, 95 and the electrode 20, 30. As a result, resistance to thermal cycle (resistance to separation) of the spark plug 100 can be enhanced.

Separation or cracking of the electrode tip material occurs due to thermal stress caused by the above-described difference in the coefficient of thermal expansion. In particular, cracking is mainly caused by material embrittlement (decrease in grain boundary strength due to hydrogen embrittlement or grain growth). In order to suppress such hydrogen embrittlement, addition of Ir, Ni, Co, and/or Fe as described above is also effective, and preferably, the amount of each element is 0.5 wt. % or more. The reason for occurrence of hydrogen embrittlement is that hydrogen is generated as a result of thermal decomposition of water and fuel in an atmosphere in the operating internal combustion engine, and the generated hydrogen diffuses in Pd, which is high in hydrogen permeability. In addition, a decrease in the grain boundary strength due to grain growth can also be suppressed by adding Ir, Ni, Co, and/or Fe as described above, and preferably, the amount of each element is 0.5 wt. % or more in order to suppress grain growth effectively.

Meanwhile, when the electrode tip material contains at least one of Ni, Co, and Fe, lowering of the melting point of the electrode tip material and oxidization of Ni, Co, and/or Fe can be suppressed if the amount of each element is limited to 40 wt. % or less. That is, a decrease in spark wear resistance can be suppressed. Accordingly, when the electrode tip material contains at least one of Ni, Co, and Fe, preferably, the amount of each element is 40 wt. % or less.

Notably, a plurality of elements among Ir, Ni, Co, and Fe may be added to the electrode tip material; however, preferably, the total amount is less than 60 wt. %. This is because, as mentioned above, the preferred amount of Pd is 40 wt. % or more.

Furthermore, preferably, the electrode tip material contains at least one of platinum (Pt), rhenium (Re), and rhodium (Rh), and ruthenium (Ru) in a total amount of 5 wt. % to 40 wt. %. When the electrode tip material contains Pt, preferably, the Pt content is 18 wt. % to 40 wt. %. When the electrode tip material contains one of Re, Rh, and Ru, preferably, the total amount of these elements is 5 wt. % to 10 wt. %. The reason for this will be described hereinafter. Melting points of Pt, Re, Rh, and Ru are higher than that of Pd, and sputtering rates of Pt, Re, Rh, and Ru are lower than that of Pd. Accordingly, addition of at least one of Pt, Re, Rh, and Ru to the electrode tip elevates the melting point of the electrode tip material, and decreases the sputtering rate. As a result, the spark wear resistance of the center electrode tip 90, 95 is enhanced. In order to enhance the spark wear resistance effectively, preferably, the total amount of Pt, Re, Rh, and Ru is 5 wt. % or more. Notably, even if the Pt content is in a range from 16 wt. % to 40 wt. %, spark wear resistance can be enhanced effectively.

Meanwhile, as in the case of the above-described Ir, if Pt, Re, Rh, or Ru is added in a large amount in a binary system of Pd and the added element, two-phase separation may occur. This results in embrittlement of the electrode tip material and lowering of workability. In view of the above-mentioned points, preferably, the amount of Pt is 40 wt. % or less, and the total amount of Re, Rh, and Ru is 10 wt. % or less. In addition, the total amount of Pt, Re, Rh, and Ru is 40 wt. % or less.

Furthermore, preferably, the electrode tip material contains any one of titanium (Ti), zirconium (Zr), hafnium (Hf), and rare earth elements in an amount of 0.05 wt. % to 0.5 wt. %, more preferably, 0.2 to 0.5 wt. %. Preferred rare earth elements are scandium (Sc), yttrium (Y), lanthanum (L), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). Among these rare earth elements, Y and Nd are particularly preferred.

Addition of Ti, Zr, Hf, or a rare earth element to the electrode tip material suppresses grain growth during operation of the internal combustion engine. As a result, the resistance to thermal cycle of the electrode tip 90, 95 can be enhanced. In order to effectively suppress grain growth, preferably, the amount of Ti, Zr, Hf, or a rare-metal element is 0.05 wt. % or more. If the amount of Ti, Zr, Hf, or a rare earth element is limited to 0.5 wt. % or less, there can be suppressed formation of oxide at the grain boundary and the joint interface with the electrode 20, 30 formed of Ni or an alloy whose predominant component is Ni; thereby suppressing deterioration in durability of the electrode tip 90, 95 due to the oxide.

Notably, Ti, Zr, Hf, or a rare-metal element may be added as an element or in the form of oxide. Even when Ti, Zr, Hf, or a rare-metal element is added in the form of oxide, similar effects are attained. That is, grain growth can effectively be suppressed by setting the incorporation amount to 0.05 wt. % or more, and a decrease in the welding strength due to high-concentration oxide formation at the joint interface between the electrode tip 90, 95 and the electrode 20, 30 and lowering of workability can be suppressed by limiting the incorporation amount to 0.5 wt. % or less.

Furthermore, preferably, the amount of unavoidable impurities contained in the electrode tip material is 0.2 wt. % or less. Notably, unavoidable impurities refer to a substance(s) which is contained in the starting material of the electrode tip material or is accidentally added to the starting material when the electrode tip material is manufactured, and which remains in the manufactured electrode tip material. In other words, unavoidable impurities are elements other than Pd, Ir, Ni, Co, Fe, Pt, Re, Rh, Ru, Ti, Zr, Hf, and rare earth elements. Examples of unavoidable impurities include boron (B), sodium (Na), aluminum (Al), silicon (Si), barium (Ba), and oxygen (O), etc.

Unavoidable impurities, which exist along the grain boundary of the electrode tip material, capture external oxygen when the spark plug is operated in the internal combustion engine, whereby wear of the electrode tip material due to oxidation is accelerated. At the same time, unavoidable impurities can cause oxidization at the grain boundary, which may cause cracking at the grain boundary. Accordingly, in order to suppress occurrence of cracking at the grain boundary, preferably, the amount of unavoidable impurities is 0.2 wt. % or less, more preferably, 0.1 wt. % or less.

Moreover, preferably, the amount of oxygen contained in the electrode tip material as an unavoidable impurity during manufacture thereof is 300 mass ppm (parts per million) or less. If the concentration of oxygen dissolved in the electrode tip material can be reduced to 300 ppm or less, so-called sweating can be restrained. Sweating means a phenomenon in which the electrode tip material partially melts when the spark plug is operated in the internal combustion engine. Sweating can cause problems such as short circuit between the center electrode tip 90 and the ground electrode tip 95.

The mechanism of sweating is considered to be as follows: In the internal combustion engine, hydrogen is generated as a result of decomposition of moisture generated through combustion or as a result of thermal decomposition of fuel. The generated hydrogen diffuses into the electrode tip material. It is known that Pd is considerably high in hydrogen dissolution capacity and permeability compared with Pt. In the case of the electrode tip material whose predominant component is Pd, hydrogen may react with the oxygen dissolved in Pd, whereby water vapor may be generated in the electrode tip material. Generation of water vapor causes expansion and internal oxidation of the electrode tip material or disassociation of water vapor into hydrogen and oxygen under a reductive condition. Through repetition of such reaction, the electrode tip material becomes spongy, and its heat conduction becomes poor. As a result, the temperature of the electrode tip material increases excessively, and the electrode tip material melts and sweats.

In order to restrain the above-described sweating, preferably, the amount of dissolved oxygen is 300 ppm or less as mentioned above.

### A3. Composition of Electrode

Next, there will be described the composition of the material (base member material) of the center electrode 20 and the ground electrode 30 to which the electrode tips 90 and 95 are joined, respectively.

Preferably, the Si content of the base material is 3 wt. % or less. As mentioned above, the base material is formed of Ni or an alloy whose predominant component is Ni. However, in some cases, Al, Cr, or Si is added so as to improve resistance to oxidation. These elements diffuse into the electrode tip 90, 95 in a high-temperature environment when the spark plug is operated in the internal combustion engine. Among these additive elements, Si undergoes eutectic reaction with Pd at a relatively low temperature. Since the amount of Si soluble in Pd is very small, diffusion of a small amount of Si causes a eutectic reaction. The eutectic temperature of Pd and Si is 821° C. When the spark plug is operated in the internal combustion engine, the temperature of the electrode tip 90, 95 reaches about 1100° C., which is higher than the eutectic temperature, which results in partial formation of a liquid phase in the electrode tip material. The liquid phase generated in the electrode tip material may, in some cases, cause a decrease in spark wear resistance, cracking due to oxidation at the grain boundary or excessive grain growth, sweating, etc., which may decrease the durability of the electrode tip 90, 95. In order to avoid the above-described problems, preferably, the Si content of the base member material is 3 wt. % or less.

### B. Experimental Example

An evaluation test was conducted using a plurality of samples (spark plugs) in order to confirm the effect of the present embodiment. Details of the evaluation test and evaluation criteria will be described later. The plurality of samples were manufactured such that they differ from one another in the combination of the type of the electrode tip material of the ground electrode tip 95 and the type of the base member material of the ground electrode 30.

Each of the electrode tip materials was manufactured by a melting method; that is, by melting Pd with a predetermined additive element(s) (Ir, Ni, Co, Fe, Pt, Re, Rh, Ru, Ti, Zr, Hf, and/or a rare earth element) at a predetermined percentage. Each electrode tip material was formed into a cylindrical ground electrode tip 95 having a diameter of 0.9 mm and a height of 0.6 mm. The amount of unavoidable impurities contained in each electrode tip material was measured by a glow-discharge mass spectrometry (GS-MS). The amount of oxygen dissolved in the electrode tip material was measured by a non-dispersive infrared method (NDIR) in a state in which the electrode tip material was heated and molted in an inert gas. Notably, when the melting method for preparing each electrode tip material was carried out in an argon (Ar) gas atmosphere, the oxygen content of the argon gas was adjusted so as to adjust the amount of oxygen dissolved in each electrode tip material. The amount of unavoidable impurities was adjusted by controlling or adjusting the purity of the additive element(s).

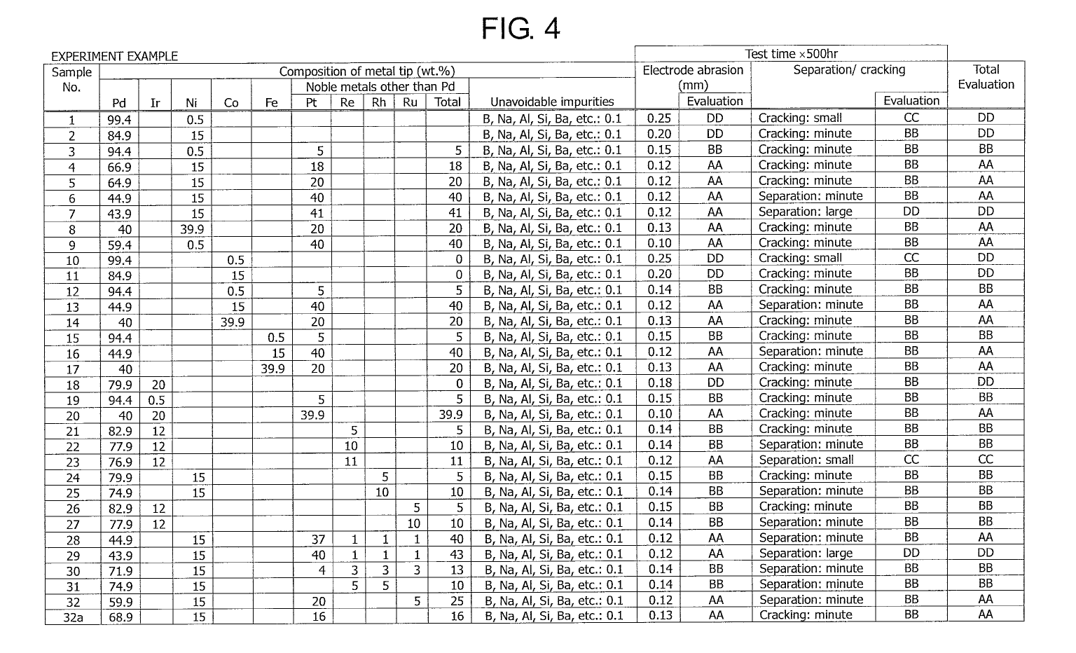

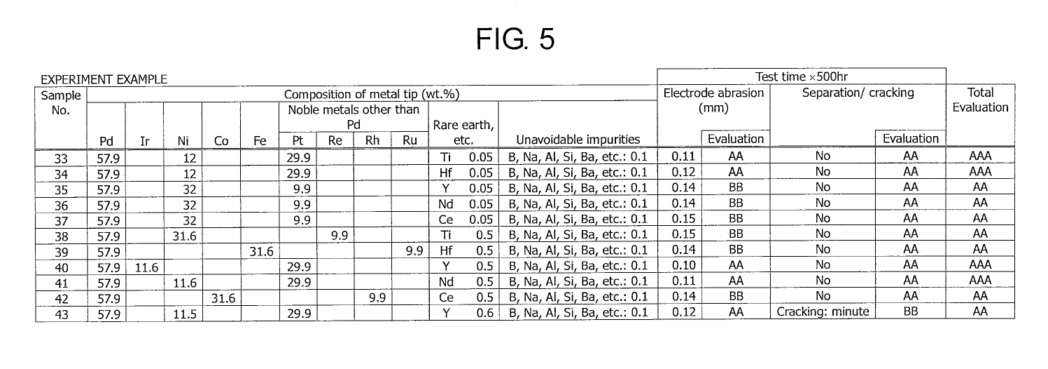

FIG. 4 and FIG. 5 are explanatory views showing, in a table form, the compositions of electrode tip materials used for Samples 1 to 43 and the results of an evaluation test performed for these samples. The amount of dissolved oxygen in Samples 1 to 37 were adjusted to 200 ppm, respectively. In addition, INCONEL 601 (commercially available material: Si content=0.2 wt. %), whose cross-sectional size is 1.3 mm×2.0 mm, was used as the base member material of the ground electrodes 30 of Samples 1 to 37.

In the evaluation test for Samples 1 to 43, each sample was mounted to a six-cylinder (displacement: 2800 cc) engine, and an on-engine operation was performed; that is, a cycle, in which the engine was operated at 5500 rpm for one minute with the throttle fully open and then held in the idling state for one minute, was repeated over a period of 500 hours. After completion of the on-engine operation, the ground electrode tip 95 of each sample was evaluated for spark wear resistance (electrode worn amount) and separation/cracking.

In the evaluation for spark wear resistance, a sample whose electrode worn amount was 0.13 mm or less was evaluated “Excellent” (AA), a sample whose electrode worn amount was more than 0.13 but not exceeding 0.15 mm was evaluated “Good” (BB), and a sample whose electrode worn amount was more than 0.15 mm was evaluated “Unacceptable” (DD). The electrode worn amount was obtained by calculating the difference between the thicknesses of the ground electrode tip 95 which were measured, through use of a metallurgical microscope, before and after the on-engine operation.

In the evaluation for separation and cracking, a sample in which neither separation nor cracking occurred was evaluated “Excellent” (AA), a sample in which minute separation or cracking occurred was evaluated “Good” (BB), and a sample in which small separation or cracking occurred was evaluated “Acceptable” (CC), and a sample in which large separation or cracking occurred was evaluated “Unacceptable” (DD).

Notably, minute separation (cracking) refers to separation (cracking) which is 0.1 mm or less in length (depth) as viewed in a cross section. Small separation (cracking) refers to separation (cracking) which is greater than 0.1 mm but not exceeding 0.2 mm in length (depth) as viewed in the cross section. Large separation (cracking) refers to separation (cracking) which is greater than 0.2 mm in length (depth) as viewed in the cross section.

In the total evaluation, a sample which was evaluated “Unacceptable” (DD) in either of the above-described evaluations was evaluated “Unacceptable” (DD), a sample which was evaluated “Good” (BB) in the evaluation on spark wear resistance but was evaluated “Acceptable” (CC) in the evaluation on separation and cracking was evaluated “Acceptable” (CC), a sample which was evaluated “Good” (BB) in both of the above-described evaluations was evaluated “Good” (BB), a sample which was evaluated “Excellent” (AA) in the evaluation on resistance spark wear or was evaluated “Excellent” (AA) in the evaluation on separation and cracking was evaluated “Excellent” (AA), and a sample which was evaluated “Excellent” (AA) in both of the above-described evaluations was evaluated “Best” (AAA).

The results of the above-described evaluation test demonstrate that an electrode tip which is superior in spark wear resistance and is less likely to separate or crack can be manufactured if the electrode tip material contains Pd in an amount of 40 wt. % or more, at least one of Ir, Ni, Co, and Fe, and any of Pt, Re, Rh, and Ru.

Also, the evaluation results demonstrate that, when the electrode tip material contains Ir, preferably, the Ir content is 0.5 wt. % to 20 wt. %. In addition, the evaluation results demonstrate that, when the electrode tip material contains at least one element of Ni, Co, and Fe, preferably, the amount of the at least one element is 0.5 wt. % to 40 wt. %.

The results of evaluation of Samples 1 to 20 demonstrate that, when the Pt content of the electrode tip material is 18 wt. % to 40 wt. %, the total evaluation result is “Excellent” (AA) and an electrode tip formed of such a material is superior in spark wear resistance and less likely to separate or crack. Moreover, the result of evaluation of Sample 32a demonstrates that, when the Pt content of the electrode tip material is 16 wt. %, the total evaluation result is also “Excellent” (AA). That is, the results of evaluation of Samples 1 to 20 and 32a demonstrate that, when the Pt content of the electrode tip material is 16 wt. % to 40 wt. %, the total evaluation result is “Excellent” (AA) and the electrode tip formed of such a material is superior in spark wear resistance and less likely to separate or crack.

In addition, the results of evaluation of Samples 21 to 27 demonstrate that, when the electrode tip material contains any one of Re, Rh, and Ru, an electrode tip which is superior in spark wear resistance and is less likely to separate or crack can be manufactured if the total amount of these elements is 5 wt. % to 10 wt. %. Moreover, the result of evaluation of Sample 29 demonstrates that preferably, the total amount of Pt, Re, Rh, and Ru is 5 wt. % to 40 wt. %.

In addition, the results of the evaluation performed for Samples 33 to 43 demonstrate that preferably, the electrode tip material contains any one of Ti, Zr, Hf, and a rare earth element and, if the electrode tip material contains any one of Ti, Zr, Hf, and a rare earth element in an amount of 0.05 wt. % to 0.5 wt. %, the total evaluation result is “Best” (AAA) or “Excellent” (AA), and an electrode tip formed of such a material is far superior in spark wear resistance and far less likely to separate or crack.

Also, the results of the evaluations demonstrate that, when the electrode tip material contains unavoidable impurities in an amount of approximately 0.1 wt. %, reduction in spark wear resistance can be suppressed, and an electrode tip which is less likely to separate or crack can be manufactured.

### C. Modifications of Embodiment

The present invention is not limited to the above-described example and embodiment, and may be practiced in various forms without departing from the scope of the invention. For example, the following modifications are possible.

### C1. Modification 1:

The above-described embodiment adopts a spark plug 100 of a vertical discharge type, wherein the center electrode tip 90 faces the ground electrode tip 95 in the axial direction OD. However, the present invention is not limited to such a spark plug. Needless to say, the present invention may be applied to a spark plug of a horizontal discharge type, in which the center electrode tip 90 faces the ground electrode tip 95 in a direction orthogonal to the axial direction OD. The positional relation between the ground electrode tip 95 and the center electrode tip 90 may be set appropriately depending on the application, required performance, etc. of the spark plug. Notably, a plurality of ground electrodes may be provided for a single center electrode.

### C2. Modification 2:

In the above-described embodiment, the same electrode tip material is used for both the center electrode tip 90 and the ground electrode tip 95. However, the above-described electrode tip material may be used for either one. The above-described ground electrode tip 95 has a flat shape; however, the ground electrode tip 95 may assume the form of an approximate cylindrical column which extends in the axial direction OD.

### DESCRIPTION OF REFERENCE NUMERALS

3: ceramic resistor
4: seal member
5: gasket
6: ring member
8: sheet packing
9: talc
10: insulator
11: front end portion
12: axial hole
13: leg portion
15: stepped portion
17: front trunk portion
18: rear trunk portion
19: flange portion
20: center electrode
21: electrode base member
22: front end portion
25: core
30: ground electrode
32: proximal end portion
33: distal end portion
40: metal terminal
50: metallic shell
51: tool engagement portion
52: mounting threaded portion
53: crimp portion
54: seal portion
55: seat surface
56: stepped portion
57: front end surface
58: contractive deformation portion
59: screw neck
90, 95: electrode tip
100: spark plug
120: laser weld
200: engine head
205: peripheral surface around the opening of the mounting threaded hole

1. A spark plug having an electrode tip at a distal end of an electrode, said electrode tip comprising:
Pd as a predominant component in an amount of 40 wt. % or more;
at least one element selected from the group consisting of Ir, Ni, Co, and Fe, wherein, when the tip contains Ir, the amount of Ir is 0.5 wt. % to 20 wt. %, and when the tip contains at least one element of Ni, Co, and Fe, the amount of the at least one element is 0.5 wt. % to 40 wt. %; and
at least one element selected from the group consisting of Pt, Re, Rh, and Ru in a total amount of 5 wt. % to 40 wt. %, wherein when the tip contains at least one element of Re, Rh, and Ru, the amount of the at least one element is 10 wt. % or less, and when the tip contains Pt, the amount of Pt is 16 wt. % to 40 wt. %.

2. The spark plug according to claim 1, wherein the electrode tip further comprises any element selected from the group consisting of Ti, Zr, Hf, and a rare earth element in an amount of 0.05 wt. % to 0.5 wt. %.
